(19) United States
(12) Patent Application Publication
(10) Pub. No.: US 2009/0305927 A1
(43) Pub. Date: Dec. 10, 2009

(54) ORGANIC COMPOSITIONS

(75) Inventors: Vikki Louise Binns, Hull (GB); Ian Keppie, Hull (GB); Hans Oliver Ribi, Hillsborough, CA (US)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 12/097,818

(22) PCT Filed: Dec. 19, 2006
(86) PCT No.: PCT/GB2006/004770

§ 371 Date: Dec. 15, 2008

(30) Foreign Application Priority Data
Dec. 20, 2005 (GB) 0525843.9

(51) Int. Cl. C11D 3/37

(52) U.S. Cl. 510/100

(57) ABSTRACT

A hard-surface treatment composition comprising:
a. a surfactant;
b. a microcrystalline, liposomal, colloidal, particulate, macromolecular, or soluble polydiacetylene polymer, or a polydiacetylene polymer supported on or associated with a carrier particulate;
c. optionally, an organic solvent; and
d. water;
   wherein, when the composition contacts a grease or oily composition, said polydiacetylene polymer changes color from a first color to a second color, or changes from a first color to a colorless appearance.

The present invention generally relates to aqueous hard surface treatment compositions.

In particular the present invention relates to aqueous hard surface treatment compositions, e.g., hard surface cleaning and/or disinfecting and/or sanitizing compositions comprising a microcrystalline, liposomal, colloidal, particulate, macromolecular, or soluble polydiacetylene polymer or, a said polymer supported on or associated with a carrier particulate which undergo a color change when contacting a fatty or hydrophobic (oleophilic) material, such as grease or oil stains as may be found on surfaces.

Hard surface cleaning compositions are commercially important products and enjoy a wide field of use, and are known to assist in the removal of dirt and grime from surfaces. Hard surfaces include those which are frequently encountered in kitchens, for example worktops, tiles, cookers, dishwashers, walls, floors, etc. Such hard surfaces may also be found in different environments as well, including bathrooms, hospitals, food service institutions, semi-conductor manufacturing, in the automotive industry, childcare and general manufacturing.

In such environments fatty materials, e.g., greasy or oily stains are frequently encountered. Similarly, stains or solid residues with some greasy functionality eg. soap scum. Such stains are surface residues which generally comprise hydrophobic materials often with further materials which leave unsightly residues on surfaces.

While the prior art provides a plethora of compositions which provide cleaning of a greasy or oily composition or stain there is a real and continuing need in the art to provide a composition which can visually indicate where a grease or oily composition stain is as well as the magnitude of its presence on the hard surface and therefore allow the user to focus their cleaning efforts to ensure that a deep down clean is achieved.

It has surprisingly been discovered that when a microcrystalline, liposomal, colloidal, particulate, macromolecular or soluble polydiacetylene polymer, as well as said polydiacetylene polymers supported on or associated with a carrier particulate, is included in a hard surface cleaning composition, a color change occurs when the hard surface cleaning composition comes into contact with fatty materials, e.g., greasy or oily stains. The presence of this polymer in the hard surface cleaning composition also allows the hard surface to be wiped clean leaving no staining.

Accordingly, in one aspect, the present invention provides a hard-surface cleaning composition comprising:

a. a surfactant;

b. a microcrystalline, liposomal, colloidal, particulate, macromolecular, supported or soluble polydiacetylene polymer;

c. optionally, an organic solvent; and

d. water;

wherein, when the composition contacts fatty materials, e.g., greasy or oily, said polydiacetylene polymer changes color from a first color to a second color or alternately, changes from a first color to a colorless appearance.

Accordingly to a second aspect of the present invention there is provided a hard-surface cleaning composition comprising:

a. a surfactant;

b. a polydiacetylene polymer supported on or associated with a carrier particulate;

c. optionally, an organic solvent; and

d. water;

wherein, when the composition contacts fatty materials, e.g., greasy or oily, said polydiacetylene polymer changes color from a first color to a second color or alternately, changes from a first color to a colorless appearance.

In a further aspect, the present invention also provides a use of the composition as defined above as a hard-surface cleaning composition.

In a yet further aspect, the present invention also provides a use of the hard-surface cleaning composition according to either the first or second aspects of the invention as defined above as a cleaning agent on a cleaning article, especially a disposable cleaning article such as a wipe, wherein water is only optionally present.

In a still further aspect of the invention there is provided a method for manufacturing a hard surface cleaning composition which comprises a microcrystalline, liposomal, colloidal, particulate, macromolecular, or soluble polydiacetylene polymer or, a said polymer supported on or associated with a carrier particulate.

According to a further aspect, the present invention further provides a method of indicating the presence of a grease or oil on a hard-surface wherein the surface is contacted with the composition as defined above.

In a yet further aspect, the present invention also provides a method of cleaning a hard-surface wherein the surface is contacted with the composition as defined above.

The hard surface treatment compositions of the invention may be used in the cleaning and/or disinfecting and/or sanitizing treatment of hard surfaces, particularly hard surfaces wherein the presence of oily or fatty soils or stains are expected or suspected to be present.

An essential constituent of the hard surface treatment compositions of the invention are one or more surfactants.

The surfactant constituent can comprise one or more non-ionic, anionic, cationic, zwitterionic or natural surfactants or mixtures thereof.

Non-limiting examples of anionic surfactants which may be used in the surfactant constituent include alcohol sulfates and sulfonates, alcohol phosphates and phosphonates, alkyl ester sulfates, alkyl diphenyl ether sulfonates, alkyl sulfates, alkyl ether sulfates, sulfate esters of an alkyphenoxy polyoxyethylene ethanol, alkyl monoglyceride sulfates, alkyl sulfonates, alkyl ether sulfates, alpha-olefin sulfonates, beta-alkoxy alkane sulfonates, alkyl ether sulfonates, ethoxylated alkyl sulfonates, alkylaryl sulfonates, alkylaryl sulfates, alkyl monoglyceride sulfonates, alkyl carboxylates, alkyl ether carboxylates, alkyl alkoxy carboxylates having 1 to 5 moles of ethylene oxide, alkylpolyglycolethersulfates (containing up to 10 moles of ethylene oxide), sulfosuccinates, octoxynol or nonoxynol phosphates, taurates, fatty taurides, fatty acid amide polyoxyethylene sulfates, acyl glycerol sulfonates, fatty oleyl glycerol sulfates, alkyl phenol ethylene oxide ether sulfates, paraffin sulfonates, alkyl phosphates, isethionates, N-acyl taurates, alkyl succinamates and sulfosuccinates, alkylpolysaccharide sulfates, alkylpolyglucoside sulfates, alkyl polyethoxy carboxylates, and sarcosinates or mixtures thereof. These anionic surfactants may be provided as salts with one or more organic counterions, e.g, ammonium, or inorganic counterions, especially as salts of one or more alkaline earth or alkaline earth metals, e.g, sodium.

Further examples of anionic surfactants include water soluble salts or acids of the formula (ROSO₃)ₓM or (RSO₃)ₓM wherein R is preferably a C₆-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a mono-, di- or tri-valent cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like) and x is an integer, preferably 1 to 3, most preferably 1. Materials sold under the Hostapur and Biosoft trademarks are examples of such anionic surfactants.

Still further examples of anionic surfactants include alkyl-diphenyl-ethersulphonates and alkyl-carboxylates.

Also useful in the anionic surfactant constituent are diphenyl disulfonates, and salt forms thereof, such as a sodium salt of diphenyl disulfonate commercially available as DOWFAX 3B2. Such diphenyl disulfonates are included in certain preferred embodiments of the invention in that they provide not only a useful cleaning benefit but concurrently also provide a useful degree of hydrotropic functionality.

Other anionic surfactants can include salts (including, for example, sodium, potassium, ammonium, and substituted ammonium salts such as mono-, di- and triethanolamine salts) of soap, C₆-C₂₀ linear alkylbenzenesulfonates, C₆-C₂₂ primary or secondary alkanesulfonates, C₆-C₂₄ olefinsulfonates, sulfonated polycarboxylic acids prepared by sulfonation of the pyrolyzed product of alkaline earth metal citrates, C₆-C₂₄ alkylpolyglycolethersulfates, alkyl ester sulfates such as C₁₄-C₁₆ methyl ester sulfates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), acyl sarcosinates, sulfates of alkylpolysaccharides such as the sulfates of alkylpolyglucoside, branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Examples of the foregoing anionic surfactants are available under the following tradenames: RHODAPON, STEPANOL, SURFINE, SANDOPAN, NEODOX, BIOSOFT, and AVANEL. A preferred anionic surfactant is sodium laurethyl sulfonate.

Examples of nonionic surfactants which may be used in the surfactant constituent include polyethylene oxide condensates of alkyl phenols. These compounds include the condensation products of alkyl phenols having an alkyl group containing from about 6 to 12 carbon atoms in either a straight chain or branched chain configuration with ethylene oxide, the ethylene oxide being present in an amount equal to 5 to 25 moles of ethylene oxide per mole of alkyl phenol. The alkyl substituent in such compounds can be derived, for example, from polymerized propylene, diisobutylene and the like. Examples of compounds of this type include nonyl phenol condensed with about 9.5 moles of ethylene oxide per mole of nonyl phenol; dodecylphenol condensed with about 12 moles of ethylene oxide per mole of phenol; dinonyl phenol condensed with about 15 moles of ethylene oxide per mole of phenol and diisooctyl phenol condensed with about 15 moles of ethylene oxide per mole of phenol.

Further useful nonionic surfactants include the condensation products of aliphatic alcohols with from about 1 to about 60 moles of ethylene oxide. The alkyl chain of the aliphatic alcohol can either be straight or branched, primary or secondary, and generally contains from about 8 to about 22 carbon atoms. Examples of such ethoxylated alcohols include the condensation product of myristyl alcohol condensed with about 10 moles of ethylene oxide per mole of alcohol and the condensation product of about 9 moles of ethylene oxide with coconut alcohol (a mixture of fatty alcohols with alkyl chains varying in length from about 10 to 14 carbon atoms). Other examples are those C₆-C₁₁ straight-chain alcohols which are ethoxylated with from about 3 to about 6 moles of ethylene oxide. Their derivation is well known in the art. Examples include Alfonic® 810-4.5 (also available as Teric G9A5), which is described in product literature from Sasol as a C₈-C₁₀ having an average molecular weight of 356, an ethylene oxide content of about 4.85 moles (about 60 wt. %), and an HLB of about 12; Alfonic® 810-2, which is described in product literature from Sasol as a C₈-C₁₀ having an average molecular weight of 242, an ethylene oxide content of about 2.1 moles (about 40 wt. %), and an HLB of about 12; and

Alfonic® 610-3.5, which is described in product literature from Sasol as having an average molecular weight of 276, an ethylene oxide content of about 3.1 moles (about 50 wt. %), and an HLB of 10. Product literature from Sasol also identifies that the numbers in the alcohol ethoxylate name designate the carbon chain length (numbers before the hyphen) and the average moles of ethylene oxide (numbers after the hyphen) in the product.

Further exemplary useful nonionic surfactants include alcohol ethoxylates including C₁₀ oxo-alcohol ethoxylates available from BASF under the Lutensol ON tradename. They are available in grades containing from about 3 to about 11 moles of ethylene oxide (available under the names Lutensol ON 30; Lutensol ON 50; Lutensol ON 60; Lutensol ON 65; Lutensol ON 66; Lutensol ON 70; Lutensol ON 80; and Lutensol ON 110). Yet further examples of ethoxylated alcohols include the Neodol® 91 series non-ionic surfactants available from Shell Chemical Company which are described as C₉-C₁₁ ethoxylated alcohols. The Neodol® 91 series non-ionic surfactants of interest include Neodol 91-2.5, Neodol 91-6, and Neodol 91-8. Neodol 91-2.5 has been described as having about 2.5 ethoxy groups per molecule; Neodol 91-6 has been described as having about 6 ethoxy groups per molecule; and Neodol 91-8 has been described as having about 8 ethoxy groups per molecule. Still further examples of ethoxylated alcohols include the Rhodasurft® DA series non-ionic surfactants available from Rhodia which are described to be branched isodecyl alcohol ethoxylates. Rhodasurf DA-530 has been described as having 4 moles of ethoxylation and an HLB of 10.5; Rhodasurf DA-630 has been described as having 6 moles of ethoxylation with an HLB of 12.5; and Rhodasurf DA-639 is a 90% solution of DA-630.

Further examples of ethoxylated alcohols include those from Tomah Products (Milton, Wis.) under the Tomadol tradename with the formula RO(CH₂CH₂O)ₙH where R is the primary linear alcohol and n is the total number of moles of ethylene oxide. The ethoxylated alcohol series from Tomah include 91-2.5; 91-6; 91-8—where R is linear C9/C10/C11 and n is 2.5, 6, or 8; 1-3; 1-5; 1-7; 1-73B; 1-9; —where R is linear C11 and n is 3, 5, 7 or 9; 23-1; 23-3; 23-5; 23-6.5—where R is linear C12/C13 and n is 1, 3, 5, or 6.5; 25-3; 25-7; 25-9; 25-12—where R is linear C12/C13 C14/C15 and n is 3, 7, 9, or 12; and 45-7; 45-13—where R is linear C14/C15 and n is 7 or 13.

Other examples of nonionic surfactants include primary and secondary linear and branched alcohol ethoxylates, such as those based on C₆-C₁₈ alcohols which further include an average of from 2 to 80 moles of ethoxylation per mol of alcohol. These examples include the Genapol UD series from Clariant, described as tradenames Genapol UD 030, C₁₁-Oxo-alcohol polyglycol ether with 3 EO; Genapol UD, 050 C₁₁-Oxo-alcohol polyglycol ether with 5 EO; Genapol UD 070, C₁₁-Oxo-alcohol polyglycol ether with 7 BO; Genapol UD 080, C₁₁-Oxo-alcohol polyglycol ether with 8 EO; Genapol UD 088, C₁₁-Oxo-alcohol polyglycol ether with 8 EO; and Genapol UD 110, C₁₁-Oxo-alcohol polyglycol ether with 11 EO.

Other examples of useful nonionic surfactants include those having a formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Surfactants of this formula are presently marketed under the Genapol® tradename, available from Clariant, Charlotte, N.C., include the 26-L series of the general formula RO(CH₂CH₂O)ₙH wherein R is a mixture of linear, even carbon-number hydrocarbon chains ranging from C₁₂H₂₅ to C₁₆H₃₃ and n represents the number of repeating units and is a number of from 1 to about 12, such as 26-L-1,26-L-1,6,26-L-2,26-L-3,26-L-5,26-L-45, 26-L-50, 26-L-60, 26-L-60N, 26-L-75, 26-L-80, 26-L-98N, and the 24-L series, derived from synthetic sources and typically contain about 55% C₁₂ and 45% C₁₄ alcohols, such as 24-L-3,24-L-45, 24-L-50, 24-L-60, 24-L-60N, 24-L-75, 24-L-92, and 24-L-98N. From product literature, the single number following the “L” corresponds to the average degree of ethoxylation (numbers between 1 and 5) and the two digit number following the letter “L” corresponds to the cloud point in ° C. of a 1.0 wt. % solution in water.

A further class of nonionic surfactants which are contemplated to be useful include those based on alkoxy block copolymers, and in particular, compounds based on ethoxy/propoxy block copolymers. Polymeric alkylene oxide block copolymers include nonionic surfactants in which the major portion of the molecule is made up of block polymeric C₂-C₄ alkylene oxides. Such nonionic surfactants, while preferably built up from an alkylene oxide chain starting group, and can have as a starting nucleus almost any active hydrogen containing group including, without limitation, amides, phenols, thiols and secondary alcohols.

One group of such useful nonionic surfactants containing the characteristic alkylene oxide blocks are those which may be generally represented by the formula (A):

HO-(EO)X(PO)_{y}(EO)_{z}—H (A)

where EO represents ethylene oxide,

PO represents propylene oxide,

y equals at least 15,

(EO)_{x+Y} equals 20 to 50% of the total weight of said compounds, and, the total molecular weight is preferably in the range of about 2000 to 15,000. These 5 surfactants are available under the PLURONIC tradename from BASF or Emulgen from Kao.

Another group of nonionic surfactants appropriate for use in the new compositions can be represented by the formula (B):

R-(EO,PO)ₐ(EO,PO)_{b}—H (B)

wherein R is an alkyl, aryl or aralkyl group, where the R group contains 1 to 20 carbon atoms, the weight percent of EO is within the range of 0 to 45% in one of the blocks a, b, and within the range of 60 to 100% in the other of the blocks a, b, and the total number of moles of combined EO and PO is in the range of 6 to 125 moles, with 1 to 50 moles in the PO rich block and 5 to 100 moles in the EO rich block.

Further nonionic surfactants which in general are encompassed by Formula B include butoxy derivatives of propylene oxide/ethylene oxide block polymers having molecular weights within the range of about 2000-5000.

Still further useful nonionic surfactants containing polymeric butoxy (BO) groups can be represented by formula (C) as follows:

RO—(BO)ₙ(EO)ₓ—H (C)

wherein
R is an alkyl group containing 1 to 20 carbon atoms,
n is about 5-15 and x is about 5-15.

Also useful as the nonionic block copolymer surfactants, which also include polymeric butoxy groups, are those which may be represented by the following formula (D):

HO-(EO)ₓ(BO)ₙ(EO)_{y}—H (D

wherein
n is about 5-15, preferably about 15,
x is about 5-15, preferably about 15, and
y is about 5-15, preferably about 15.

Still further useful nonionic block copolymer surfactants include ethoxylated derivatives of propoxylated ethylene diamine, which may be represented by the following formula:

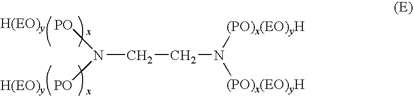

where
(EO) represents ethoxy,
(PO) represents propoxy,
   the amount of (PO)ₓ is such as to provide a molecular weight prior to ethoxylation of about 300 to 7500, and the amount of (EO) is such as to provide about 20% to 90% of the total weight of said compound.
   Surfactants based on amine oxides are also contemplated to be useful in the surfactant constituent in the present inventive compositions. Exemplary amine oxides include:
   A) Alkyl di(lower alkyl) amine oxides in which the alkyl group has about 10-20, and preferably 12-16 carbon atoms, and can be straight or branched chain, saturated or unsaturated. The lower alkyl groups include between 1 and 7 carbon atoms. Examples include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide;
   B) Alkyl di(hydroxy lower alkyl) amine oxides in which the alkyl group has about 10-20, and preferably 12-16 carbon atoms, and can be straight or branched chain, saturated or unsaturated. Examples are bis(2-hydroxyethyl) cocoamine oxide, bis(2-hydroxyethyl) tallowamine oxide; and bis(2-hydroxyethyl) stearylamine oxide;
   C) Alkylamidopropyl di(lower alkyl) amine oxides in which the alkyl group has about 10-20, and preferably 12-16 carbon atoms, and can be straight or branched chain, saturated or unsaturated. Examples are cocoamidopropyl dimethyl amine oxide and tallowamidopropyl dimethyl amine oxide; and
   D) Alkylmorpholine oxides in which the alkyl group has about 10-20, and preferably 12-16 carbon atoms, and can be straight or branched chain, saturated or unsaturated.

Preferably the amine oxide constituent is an alkyl di(lower alkyl) amine oxide as denoted above and which may be represented by the following structure:

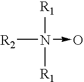

wherein each:

R₁ is a straight chained C₁-C₄ alkyl group, preferably both R₁ are methyl groups; and,

R₂ is a straight chained C₈-C₁₈ alkyl group, preferably is C₁₀-C₁₄ alkyl group, most preferably is a C₁₂ alkyl group. Each of the alkyl groups may be linear or branched, but most preferably are linear. Most preferably the amine oxide constituent is lauryl dimethyl amine oxide. Technical grade mixtures of two or more amine oxides may be used, wherein amine oxides of varying chains of the R₂ group are present. Further classes of surfactants which are contemplated as being useful in the cosurfactant constituent include alkylmonoglyocosides and alkylpolyglycosides which include known nonionic surfactants which are alkaline and electrolyte stable.

Alkylmonoglycosides and alkylpolyglycosides are prepared generally by reacting a monosaccharide, or a compound hydrolyzable to a monosaccharide with an alcohol such as a fatty alcohol in an acid medium. Various glycoside and polyglycoside compounds including alkoxylated glycosides and processes for making them are disclosed in U.S. Pat. Nos. 2,974,134; 3,219,656; 3,598,865; 3,640,998; 3,707,535, 3,772,269; 3,839,318; 3,974,138; 4,223,129 and 4,528,106. One exemplary group of such useful alkylpolyglycosides include those according to the formula:

R₂O—(CₙH₂ₙO)ᵣ-(Z)ₓ

wherein:
R₂ is a hydrophobic group selected from alkyl groups, alkylphenyl groups, hydroxyalkylphenyl groups as well as mixtures thereof, wherein the alkyl groups may be straight chained or branched, and which contain from about 8 to about 18 carbon atoms, n has a value of 2-8, especially a value of 2 or 3; r is an integer from 0 to 10, but is preferably 0, Z is derived from glucose; and, x is a value from about 1 to 8, preferably from about 1.5 to 5. Preferably the alkylpolyglycosides are nonionic fatty alkylpolyglucosides which contain a straight chain or branched chain C₈-C₁₅ alkyl group, and have an average of from about 1 to 5 glucose units per fatty alkylpolyglucoside molecule. More preferably, the nonionic fatty alkylpolyglucosides which contain straight chain or branched C₈-C₁₅ alkyl group, and have an average of from about 1 to about 2 glucose units per fatty alkylpolyglucoside molecule. Exemplary useful include, for example APG 325 CS Glycoside® which is described as being a 50% C₉-C₁₁ alkyl polyglycoside, also commonly referred to as D-glucopyranoside, (commercially available from Henkel KGaA) and Glucopon® 625 CS which is described as being a 50% C₁₀-C₁₆ alkyl polyglycoside, also commonly referred to as a D-glucopyranoside, (ex. Henkel).

By way of non-limiting example exemplary amphoteric surfactants, also known as zwitterionic surfactants, which are contemplated to be useful in the surfactant constituent include one or more water-soluble sulfobetaine surfactants such as sulfobetaine-12 and betaine surfactants which may be represented by the general formula:

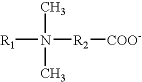

wherein R₁ is an alkyl group containing from 8 to 18 carbon atoms, or the amido radical which may be represented by the following general formula:

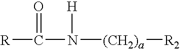

wherein R is an alkyl group having from 8 to 18 carbon atoms, a is an integer having a value of from 1 to 4 inclusive, and R₂ is a C₁-C₄ alkylene group. Examples of such water-soluble betaine surfactants include dodecyl dimethyl betaine, as well as cocoamidopropylbetaine.

The inventive compositions can include at least one cationic surfactant having germicidal properties. Such are advantageously included if the hard surface treatment composition is intended to provide a germicidal and/or sanitizing benefit.

Particularly preferred for use as the cationic surfactant having germicidal properties are those cationic surfactants which are found to provide a broad antibacterial or sanitizing function. Any cationic surfactant which satisfies these requirements may be used and are considered to be within the scope of the present invention, and mixtures of two or more cationic surface active agents, viz., cationic surfactants may also be used. Cationic surfactants are well known, and useful cationic surfactants may be one or more of those described for example in McCutcheon's Functional Materials, Vol. 2, 1998; Kirk-Othmer, Encyclopaedia of Chemical Technology, 4th Ed., Vol. 23, pp. 478-541 (1997. These are also described in the respective product specifications and literature available from the suppliers of these cationic surfactants.

Examples of preferred cationic surfactant compositions useful in the practice of the instant invention are those which provide a germicidal effect to the concentrate compositions, and especially preferred are quaternary ammonium compounds and salts thereof, which may be characterised by the general structural formula:

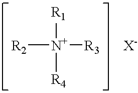

where at least one of R₁, R₂, R₃ and R₄ is a alkyl, aryl or alkylaryl substituent of from 6 to 26 carbon atoms, and the entire cation portion of the molecule has a molecular weight of at least 165. The alkyl substituents may be long-chain alkyl, long-chain alkoxyaryl, long-chain alkylaryl, halogen-substituted long-chain alkylaryl, long-chain alkylphenoxyalkyl, arylalkyl, etc. The remaining substituents on the nitrogen atoms other than the above mentioned alkyl substituents are hydrocarbons usually containing no more than 12 carbon atoms. The substituents R₁, R₂, R₃ and R₄ may be straight-chained or may be branched, but are preferably straight-chained, and may include one or more amide, ether or ester linkages. The counterion X may be any salt-forming anion which permits water solubility of the quaternary ammonium complex.

Exemplary quaternary ammonium salts within the above description include the alkyl ammonium halides such as cetyl trimethyl ammonium bromide, alkyl aryl ammonium halides such as octadecyl dimethyl benzyl ammonium bromide, N-alkyl pyridinium halides such as N-cetyl pyridinium bromide. Other suitable types of quaternary ammonium salts include those in which the molecule contains either amide, ether or ester linkages such as octyl phenoxy ethoxy ethyl dimethyl benzyl ammonium chloride and N-(laurylcocoaminoformylmethyl)-pyridinium chloride. Other very effective types of quaternary ammonium compounds which are useful as germicides include those in which the hydrophobic radical is characterised by a substituted aromatic nucleus as in the case of lauryloxyphenyltrimethyl ammonium chloride, cetylaminophenyltrimethyl ammonium methosulfate, dodecylphenyltrimethyl ammonium methosulfate, dodecylbenzyltrimethyl ammonium chloride and chlorinated dodecylbenzyltrimethyl ammonium chloride.

Preferred quaternary ammonium compounds which act as germicides and which are to be found useful in the practice of the present invention include those which have the structural formula:

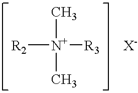

Wherein R₂ and R₃ are the same or different C₈-C₁₂alkyl, or R₂ is C₁₂₋₁₆alkyl, C₈₋₁₈alkylethoxy, C₈₋₁₈alkylphenoxyethoxy and R₃ is benzyl, and X is a halide, for example chloride, bromide or iodide, or is a methosulfate anion. The alkyl groups recited in R₂ and R₃ may be straight-chained or branched, but are preferably substantially linear.

Particularly useful quaternary germicides include compositions which include a single quaternary compound, as well as mixtures of two or more different quaternary compounds. Such useful quaternary compounds are available under the BARDAC®, BARQUAT®, HYAMINE®, LONZABAC®, and ONYXIDE® trademarks, which are more fully described in, for example, McCutcheon's Functional Materials (Vol. 2), North American Edition, 1998, as well as the respective product literature from the suppliers identified below. For example, BARDAC® 205M is described to be a liquid containing alkyl dimethyl benzyl ammonium chloride, octyl decyl dimethyl ammonium chloride; didecyl dimethyl ammonium chloride, and dioctyl dimethyl ammonium chloride (50% active)(also available as 80% active (BARDAC® 208M)); described generally in McCutcheon's as a combination of alkyl dimethyl benzyl ammonium chloride and dialkyl dimethyl ammonium chloride); BARDAC® 2050 is described to be a combination of octyl decyl dimethyl ammonium chloride/didecyl dimethyl ammonium chloride, and dioctyl dimethyl ammonium chloride (50% active)(also available as 80% active (BARDAC® 2080)); BARDAC® 2250 is described to be didecyl dimethyl ammonium chloride (50% active); BARDAC® LF (or BARDAC® LF-80), described as being based on dioctyl dimethyl ammonium chloride (BARQUAT® MB-50, MX-50, OJ-50 (each 50% liquid) and MB-80 or MX-80 (each 80% liquid) are each described as an alkyl dimethyl benzyl ammonium chloride; BARDAC® 4250 and BARQUAT® 4250Z (each 50% active) or BARQUAT® 4280 and BARQUAT® 4280Z (each 80% active) are each described as alkyl dimethyl benzyl ammonium chloride/alkyl dimethyl ethyl benzyl ammonium chloride. Also, HYAMINE® 1622, described as diisobutyl phenoxy ethoxy ethyl dimethyl benzyl ammonium chloride (50% solution); HYAMINE® 3500 (50% actives), described as alkyl dimethyl benzyl ammonium chloride (also available as 80% active (HYAMINE® 3500-80)); and HYMAINE® 2389 described as being based on methyldodecylbenzyl ammonium chloride and/or methyldodecylxylene-bis-trimethyl ammonium chloride. (BARDAC®, BARQUAT® and HYAMINE® are presently commercially available from Lonza, Inc. Fairlawn, N.J.). BTC® 50 NF (or BTC® 65 NF) is described to be alkyl dimethyl benzyl ammonium chloride (50% active); BTC® 99 is described as didecyl dimethyl ammonium chloride (50% active); BTC® 776 is described to be myrisalkonium chloride (50% active); BTC® 818 is described as being octyl decyl dimethyl ammonium chloride, didecyl dimethyl ammonium chloride, and dioctyl dimethyl ammonium chloride (50% active) (available also as 80% active (BTC® 818-80%)); BTC® 824 and BTC® 835 are each described as being of alkyl dimethyl benzyl ammonium chloride (each 50% active); BTC® 885 is described as a combination of BTC® 835 and BTC® 818 (50% active) (available also as 80% active (BTC® 888)); BTC® 1010 is described as didecyl dimethyl ammonium chlorides (50% active) (also available as 80% active (BTC® 1010-80)); BTC® 2125 (or BTC® 2125 M) is described as alkyl dimethyl benzyl ammonium chloride and alkyl dimethyl ethylbenzyl ammonium chloride (each 50% active) (also available as 80% active (BTC® 2125 80 or BTC® 2125 M)); BTC® 2565 is described as alkyl dimethyl benzyl ammonium chloride (50% active) (also available as 80% active (BTC® 2568)); BTC® 8248 (or BTC® 8358) is described as alkyl dimethyl benzyl ammonium chloride (80% active) (also available as 90% active (BTC® 8249)); ONYXIDE® 3300 is described as n-alkyl dimethyl benzyl ammonium saccharinate (95% active). (BTC® and ONYXIDE® are presently commercially available from Stepan Company, Northfield, Ill.) Polymeric quaternary ammonium salts based on these monomeric structures are also considered desirable for the present invention. One example is POLYQUAT®, described as being a 2-butenyldimethyl ammonium chloride polymer.

The selection of a surfactant will depend on the product application of interest, the phase state of the hard surface treatment composition, viz., if provided as a liquid, solid, gel, or wiping article containing the components of the hard surface treatment composition and compatibility of the polydiacetylenic polymer with the surfactant composition.

The one or more surfactants may be present in any effective amount, generally at least from about 0.0001% wt. Advantageously the one or more surfactants which comprise the surfactant constituent are present in amounts of between about 0.001% wt. and 50% wt., more preferably are present in amounts of from about 0.01-10 wt %, still more preferably in amounts from about 0.1-5 wt %, and most desirably are present in amounts of from about 0.5-2.5 wt % based on the total weight of the composition.

In certain embodiments of the invention, it may be advantageous to covalently couple the surfactant molecule to a diacetylenic or polydiacetylenic molecule or to apply the diacetylenic composition to a solid substrate or an applicator including but not limited to a wiping article, such as a fibrous wiping article which is discussed in more detail hereinafter. Synthetic coupling can provide a particularly advantageous means of composition preparation, formulation and product stabilization.

The composition of the present invention further comprises a microcrystalline, liposomal, colloidal, particulate, macromolecular, or soluble polydiacetylene polymer or a polydiacetylene polymer supported on or associated with a carrier particulate

Polydiacetylenes as a class of chromic agents have been discovered to exhibit a broad range of beneficial characteristics. They have a large extinction coefficient showing a high color contrast, so that proportionally less chromic change material may be required to achieve an optical effect than materials such as entrapped dyes. Polydiacetylenes are organic compounds and can be modified to create a wide range of forms applicable to different chromic triggering applications and processing methods. They can be structurally modified to have more than one intrinsic color change (e.g. blue-magenta-red or blue red-yellow). They can be made structurally inert such that they are odourless. They can be made into stable forms making them good candidates for tolerating the stresses of production, shipping and storage. Reversible and irreversible forms of polydiacetylenic materials can be utilized depending on the specific application of interest. All of the above variants of polydiacetylenes are considered to fall within the scope of the present invention.

The reaction speed of the polydiacetylenic polymer to indicate the presence of fatty materials, e.g., greasy or oily stains and its stability in finished formulation in absence of such materials can be affected by many variables, including but not limited to chain length, position of the diacetylene group or groups within the polymer backbone, particle size of the polymer, polarity of the head and tail group moieties, degree of hydrogen bonding within or between polymer molecules, hydrophobicity of the head an tail group moieties, level of moisture present when delivered from a substrate and size of droplet when delivered from a spray.

Likewise, partitioning agents can be added to formulations that facilitate the transport of a micro-crystalline polymer from an aqueous cleaning solution phase to a hydrophilic grease phase. Partitioning agents can include, but are not limited to organic solvents, emulsifiers, chaotropic compounds, organic additives and the like. When present, one or more partitioning agents can be present in amounts of from 0.01% to 50% by weight or volume, preferably from between 0.1% to 30%, and particularly from between 1% to 10% by weight or volume based on the total weight of the hard surface treatment compositions of which they form a part.

In a preferred embodiment the polydiacetylene polymer is a polymer comprising at least one diacetylene monomer of formula:

R(CH₂)ₙ(C≡C)₂(CH₂)ₘY

wherein:

Y is —COX, unsubstituted or substituted amino, amide, hydroxy, unsubstituted or substituted alkoxy having from 1 to 6 carbon atoms, —SH, unsubstituted or substituted alkylthio having from 1 to 20 carbon atoms, cyano or halo;

m is at least 1, preferably from 1 to 24, most preferably from 2 to 12;

n is at least 1, preferably from 6 to 36, most preferably 8 to 20;

R is H or Y, preferably H; and

X is H, OH, unsubstituted or substituted amino, unsubstituted or substituted alkoxy or polyalkyleneoxy, wherein the alkylene group has 1 to 3 carbon atoms and may have from 1 to 50 units, preferably 1 to 30, most preferably 1 to 5.

The polydiacetylene polymer advantageously is comprised of at least 50%, preferably at least 70%, more preferably at least 80%, yet more preferably in order of preference, at least 85%, 87%, 89%, 90%, 91%, 92%, 93%, 94%, 95%, 96%, 97%, 98%, 98.5%, 99%, 99.2%, 99.4%, 99.5%, 99.6%, 99.7%, 99.75%, 99.8%, 99.85%, 99.9%, 99.95%, 9.97%, 99.98, 99.99%, and most preferably 100% of one or more diacetylene monomers, preferably one or more of the diacetylene monomers (a)-(l) disclosed below.

Color change reactivity to grease as well as color stability in cleaning solution environments may be increased or decreased by altering the chemical structure of the diacetylene monomer and/or the polydiacetylene polymer. The addition of amide linkages to the polar head group increase stability in treatment compositions by improving hydrogen bonding characteristics without adversely affecting or impacting color change reactivity due to contact with grease. Various structural changes including head group composition, chain length, hydrogen bonding characteristics, polymer position within or along the hydrocarbon backbone, the addition of side-chain substituents or the like may find use in increasing or decreasing reactivity to grease while preserving or improving color stability in cleaning solutions.

Preferably, Y is of formula —COX where X is —NH—CH₃, —NH—(CH₂)ₚ—CH₃, —NH—(CH₂)ₚ—OH wherein p is from 1 to 20, more preferably p is from 1 to 4 yet more preferably p is 1 or 2 but most preferably p is 1. The diacetylene monomer can be, for example, in a preferred embodiment of the foregoing formula be a monomer according to the following structure:

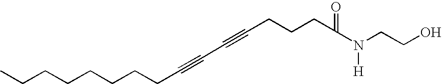

A more preferred embodiment of a diacetylene monomer is represented by the following structure:

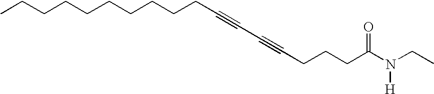

Positioning the polymeric group relative to the polar head group may find benefit depending on the formulation and application of interest. Positioning the polymeric group further distal or away from the polar head group can be useful for increasing reactivity by reducing stability characteristics resulting from stabilizing hydrogen bonding forces resulting from the head group. Distal positions such as the 8,10 position; the 10,12 position; and the 12,14 position or further may may increase reactivity than close proximity positions such as the 3,5 position′ 4,6 position; or 5,7 position. Likwise, positioning of the polymeric group may be off-set by other structural characteristics of the molecule as well.

Monomers can possess single or multiple hydrocarbon chains. Single chains find use for forming microcrystalline layers, particulates, micellular structures and various macromolecular structures such as tubes and more complex microstructures. Dual and multi-chain monomer forms find use for forming colloidal structures such as single layered, leptosomes, multi-layered liposomes and other micellular structures. Further, whereas the preferred polydiacetylene monomers comprises a single diacetylene moiety as disclosed above, it is contemplated that useful polydiacetylene monomers may comprise two or more diacetylene moieties per monomer.

Non-limiting examples of suitable monomers which make up the microcrystalline polydiacetylene polymer which can be used in the inventive compositions are as follows:

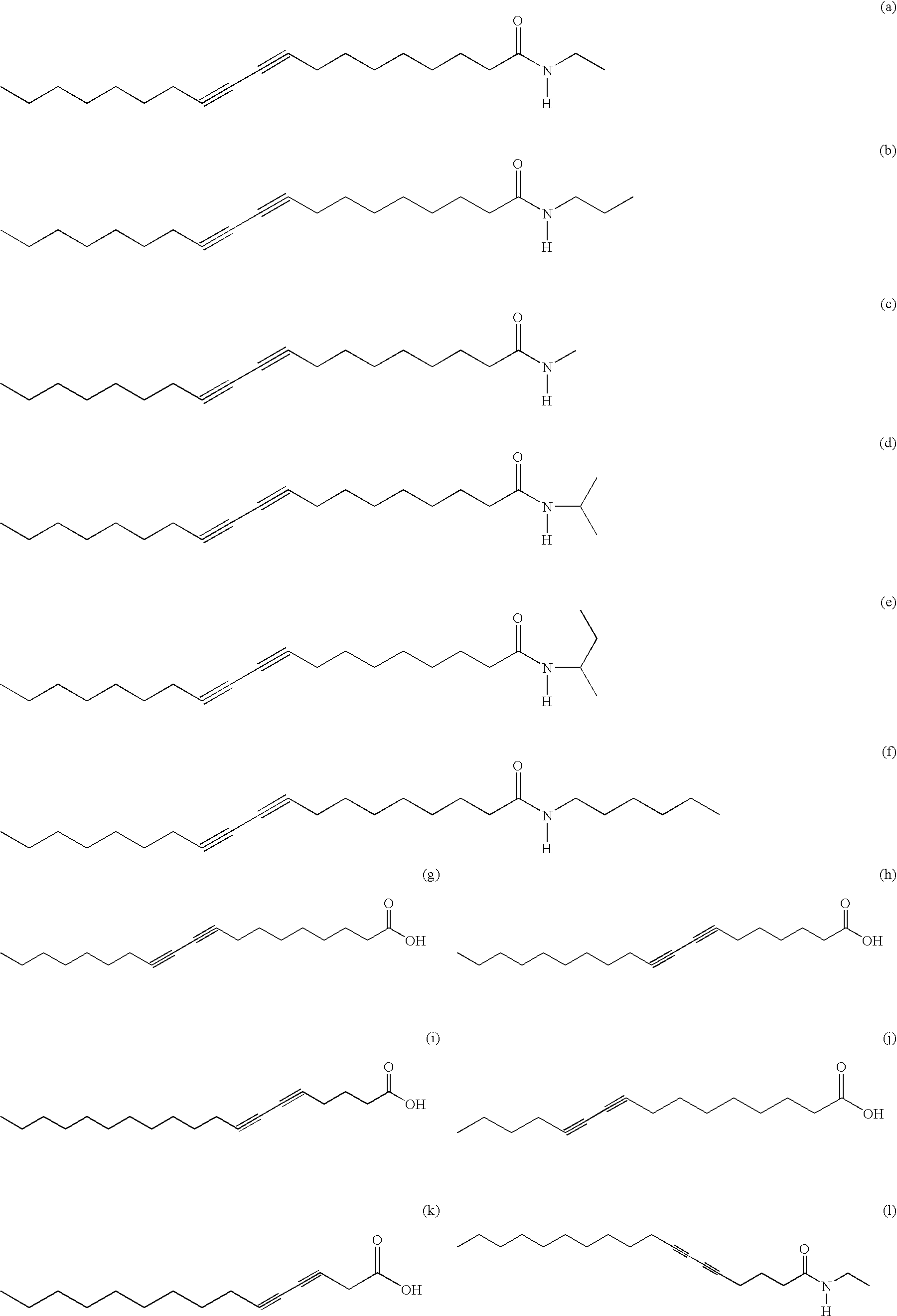

In an even more preferred embodiment the monomer is (a), (c) or (l), particularly (l).

Monomers (a) to (f) and (l) can be made by the following generally reaction mechanism:

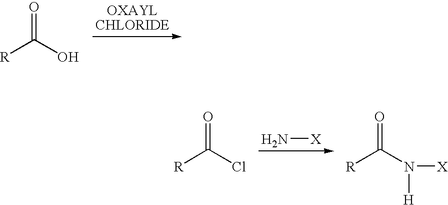

For Example monomer (a) can be made from:

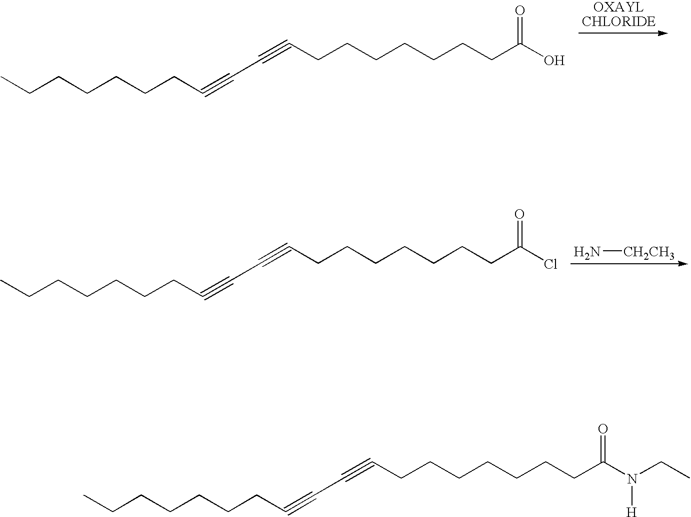

Monomers made in this way from an acid chloride coupling reaction can yield superior purity and reactivity versus the same monomers made from a DCC coupling route.

Monomers (g) to (k) can be made by the reaction of an appropriate alkyne with an appropriate alkyne substituted carboxylic acid. For example monomer (g) can be made by reacting 1-decyne with 10-undecynoic acid as illustrated below:

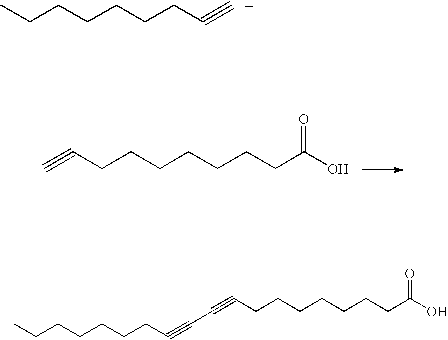

It is, however, to be understood that any suitable or standard reaction mechanism or synthetic pathway can be used to make the monomers used in the present invention. Likewise, certain precursor compounds and analogs can be purchased commercially (for example, GSF Chemicals, Columbus Ohio).

The polydiacetylene polymers of the invention may be formed from one or more of the polydiacetylene monomers disclosed above and in particular include one or more monomers disclosed above as (a)-(l) and especially preferably is polymerized essentially from, that is to say, at least 99.9%, preferably at least 99.99% of polydiacetylene monomers to the substantial exclusion of non-polydiacetylene comonomers. Polymerization may occur under various conditions which may be known to the art, e.g., exposure to ultraviolet light. As illustrative reaction process is as follows:

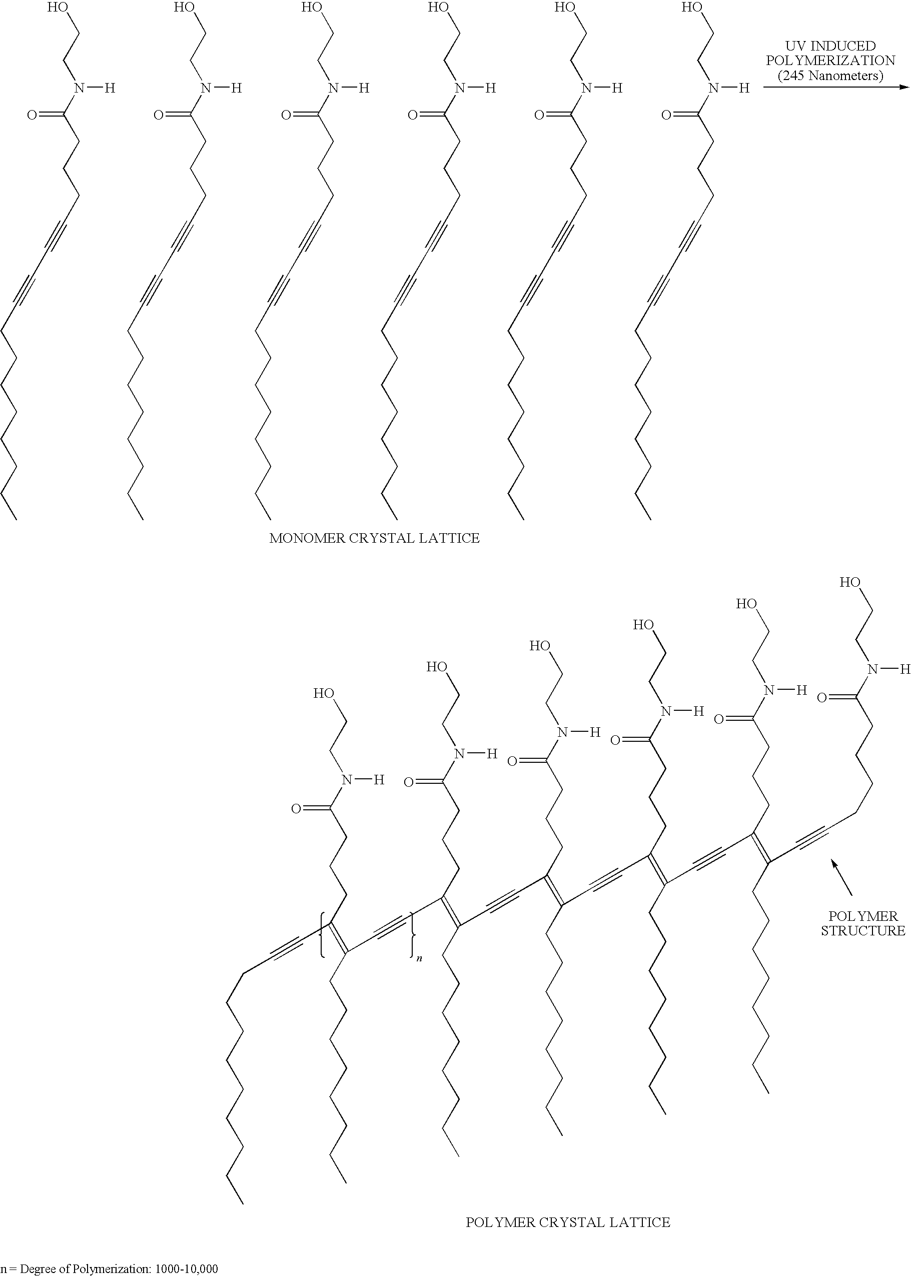

In the foregoing reaction scheme, while a single homopolymer is depicted and is preferred according to certain aspects of the invention, it is to be understood that the polydiacetylene polymers may contain mixed co-monomers particularly advantageously one or more co-monomers of selected from (a)-(l) illustrated above.

The polydiacetylene polymers may have an average molecular weight on the order from several hundreds to several millions. Advantageously the degree of polymerization is from about 100 to about 250,000, but preferably is from about 1000 to about 15,000.

In the hard surface treatment compositions taught herein, the polydiacetylene polymer may be present in any effective amount which is observed to indicate a color change when contacted with an oleophilic (lipophilic) stain or deposit as discussed herein, or when contacted with soap scum. Advantageously, the polydiacetylene polymer is present in an amount of from about 0.001 to 10 wt %, preferably in an amount of from about 0.01 to 5 wt %, but is most desirably present in an amount of from about 0.1 to 0.5 wt %., and especially advantageously about 0.2 to 0.35%, and particularly about 0.22% to 0.27% wt. based on the total weight of the composition of which it forms a part.

The polydiacetylene polymer may be provided in the foregoing weight percentages in a microcrystalline, liposomal, colloidal, particulate, macromolecular or soluble polydiacetylene polymer form, as well as a polydiacetylene polymer supported on or associated with a carrier particulate. Accordingly the polydiacetylene polymer may be provided in a so-called unsupported form wherein it is provided in a microcrystalline, liposomal, colloidal, particulate, macromolecular or soluble polydiacetylene polymer form. Alternately the polydiacetylene polymer may be provided in a so-called supported form wherein it is provided as a polydiacetylene polymer supported on or associated with a carrier particulate. The carrier particulate may be any organic or inorganic material, including but not limited to oxides, e.g., calcined aluminum oxides and the like, carbonates, e.g., calcium carbonate and the like, quartzes, siliceous chalk, diatomaceous earth, colloidal silicon dioxide, alkali metasilicates, e.g., sodium metasilicate and the like, perlite, pumice, feldspar, calcium phosphate, organic materials based on comminuted or particulate polymers especially one or more of polyolefins, polyethylenes, polypropylenes, polyesters, polystyrenes, acetonitrile-butadiene-styrene resins, melamines, polycarbonates, phenolic resins, epoxies and polyurethanes, natural materials such as, for example, rice hulls, corn cobs, and the like, or talc and mixtures thereof. The size of the carrier particulate agent typically may range from about 0.01 μm to about 10,000 μm, preferably between about 1 μm to about 1000 μm, and more preferably between about 1 μm and about 100 μm. The polydiacetylene polymer may be absorbed or adsorbed onto the carrier particulate.

When the composition comes into contact with a greasy or oily soil or composition, e.g. a lipophilic stain or soil on a hard surface, the said polydiacetylene polymer changes color from a first color to a second color. The change can also be from a first color to colorless. While not wishing to be bound by the following, it is theorised that the color change is brought about when the polymer interacts with a greasy or oily solution due to a conformational change in the polymer backbone and prompted by the interaction between the polymer's side-chains and the grease or oil components of a soil or stain. The compositions are desirably used at room temperature, i.e. 20° C., but find use under conditions wherein the hard surface treatment composition remains fluid, or alternately wherein it is observed that the polydiacetylene polymer exhibits a color changing behaviour when contacted with the grease or oil components of a soil or stain

Interactivity of the hard surface treatment composition and a grease or oil soil, stain or other oleophilic residue can be selectively adjusted utilizing differing side-chain hydrocarbon lengths, substituents appended to the monomer, positioning of the diacetylenic moiety in relationship to other groups on the monomer, the degree to which the monomer can be made to be reversible or irreversible in color change, the degree of inter and intramolecular hydrogen bonding that has been incorporated and combinations thereof.

Visual and performance characteristics of the hard surface treatment composition can be further modified and dictated by the particle size that the material is processed into. Sizes of polydiacetylenic particulates can range from visually large particle sizes to microscopically small particles. Particulates can be macro-crystalline, microcrystalline or sub-visually microscopic. Particle sizes can range from greater than 5 millimetres to sub-nanometre sizes. Usually, particles of interest will range in size from 1 millimetre to 10 nanometres. More often, particulate sizes of use will range in size from 100 microns to 0.5 microns. Typically, particles of use will range from 10 microns to 1 micron in diameter.

Smaller particulate sizes react more quickly with oil and grease to change color whereas larger particulate size react more slowly. Particulate sizes can be formulated and made with a particular rate of grease and oil reactivity intended. In certain cases, it is desirable to regulate the rate of reaction. In some cases, it is desirable to formulate cleaning products that react vividly and rapidly with grease and oil. In other cases, it may be desirable for a cleaning product to exhibit a slow or delayed color change reaction due to interaction with grease and oil. Color change reaction rates can be formulated to range from between 1 millisecond and several hours. Usually, reaction rates will be formulated to between 100 milliseconds and 1 hour. Most often color change reaction rates between 1 second and 30 seconds will find the majority of uses.

For sprayable liquid formulations, control of droplet size is a further way to provide the desired color change reaction rate. Smaller droplets will typically require the grease or oily material to diffuse less far from the surface of the spray droplet to the polymer before color change can occur.

The use of partitioning agents in combination with controlling droplet size can further can facilitate the transport of a micro-crystalline polymer from an aqueous cleaning solution phase to a hydrophobic grease phase. Partitioning agents that can be used in combination with other physical color change induction methods can include, but are not limited to organic solvents, emulsifiers, chaotropic compounds, organic additives and the like. Partitioning agents can be utilized from concentrations in a final formulation from 0.01% to 50%. More usually, they will find use from between 0.1% to over 30%. Typically, they will be added from between 1% to 10% by volume.

For liquid products, stability and speed of color change may be increased by suspending the monomer in an emulsifier, then dilution and addition of the remaining formulation ingredients prior to polymerisation. For formulations applied to a substrate eg a non-woven cloth, stability and speed of color change may be increased by drying a suspension of the monomer onto the substrate, polymerizing with ultraviolet radiation whilst in dry form, then addition of the remaining liquid formulation ingredients.

Importantly, the crystalline structure, size, shape and intimacy with the supporting non-woven substrate, can be modified or altered to increase or decrease reactivity to grease or other contaminating agents that are intended for cleaning. The hard surface treatment compositions of the invention may comprise one or more organic solvents. Exemplary useful organic solvents which may be present in the inventive compositions include those which are at least partially water-miscible such as alcohols (e.g., C₁-C₁₀ alcohols, such as, for example, ethanol, propanol, isopropanol and n-decanol), glycols (such as, for example, ethylene glycol, propylene glycol and hexylene glycol), water-miscible ethers (e.g. diethylene glycol diethylether, diethylene glycol dimethylether and propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether, dipropylene glycol N-butyl ether), C₁-C₆ esters of monoalkylethers of ethylene glycol or propylene glycol (e.g. propylene glycol monomethyl ether acetate), and mixtures thereof. Glycol ethers having the general structure Ra—Rb—OH, wherein Ra is an alkoxy of 1 to 20 carbon atoms, or aryloxy of at least 6 carbon atoms, and Rb is an ether condensate of propylene glycol and/or ethylene glycol having from one to ten glycol monomer units, may be used. Monoethanolamine may also be used. Mixtures of two or more specific organic solvents may be used, or alternately a single organic solvent may be provided as the organic solvent constituent. When present, of the foregoing classes of organic solvents, one or more glycol ethers or monohydric alcohols, especially C₁-C₄ alcohols are preferably used. When present such organic solvent(s) may be present in amounts of up to about 10 wt %, preferably are present in amounts of from about 0.01-1.0 wt %.

The inventive compositions may optionally include one or more further constituents useful in improving one or more aesthetic characteristics or the compositions or in improving one or more technical characteristics of the compositions. Exemplary further optional constituents include coloring agents, fragrances and fragrance solubilizers, viscosity modifying agents including one or more thickeners, pH adjusting agents and pH buffers including organic and inorganic salts, optical brighteners, opacifying agents, hydrotropes, abrasives, and preservatives, as well as other optional constituents providing improved technical or aesthetic characteristics known to the relevant art. When present, the total amount of such one or more optional constituents present in the inventive compositions do not exceed about 10 w % t, preferably do not exceed 5 wt. %, and most preferably do not exceed 1.2 wt %. A color changing material may also be used to modify or enhance the color change of the polydiacetylene polymer.

By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. When present, the pH adjusting agent, especially the pH buffers are present in an amount effective in order to maintain the pH of the hard surface treatment composition within a target pH range.

The hard surface treatment compositions of the invention desirably include a fragrance constituent. Fragrance raw materials may be divided into three main groups: (1) the essential oils and products isolated from these oils; (2) products of animal origin; and (3) synthetic chemicals.

The essential oils consist of complex mixtures of volatile liquid and solid chemicals found in various parts of plants. Mention may be made of oils found in flowers, e.g., jasmine, rose, mimosa, and orange blossom; flowers and leaves, e.g., lavender and rosemary; leaves and stems, e.g., geranium, patchouli, and petitgrain; barks, e.g., cinnamon; woods, e.g., sandalwood and rosewood; roots, e.g., angelica; rhizomes, e.g., ginger; fruits, e.g., orange, lemon, and bergamot; seeds, e.g., aniseed and nutmeg; and resinous exudations, e.g., myrrh. These essential oils consist of a complex mixture of chemicals, the major portion thereof being terpenes, including hydrocarbons of the formula (CSH8)n and their oxygenated derivatives. Hydrocarbons such as these give rise to a large number of oxygenated derivatives, e.g., alcohols and their esters, aldehydes and ketones. Some of the more important of these are geraniol, citronellol and terpineol, citral and citronellal, and camphor. Other constituents include aliphatic aldehydes and also aromatic compounds including phenols such as eugenol. In some instances, specific compounds may be isolated from the essential oils, usually by distillation in a commercially pure state, for example, geraniol and citronellal from citronella oil; citral from lemon-grass oil; eugenol from clove oil; linalool from rosewood oil; and safrole from sassafras oil. The natural isolates may also be chemically modified as in the case of citronellal to hydroxy citronellal, citral to ionone, eugenol to vanillin, linalool to linalyl acetate, and safrol to heliotropin.

Animal products used in perfumes include musk, ambergris, civet and castoreum, and are generally provided as alcoholic tinctures.

The synthetic chemicals include not only the synthetically made, also naturally occurring isolates mentioned above, but also include their derivatives and compounds unknown in nature, e.g., isoamylsalicylate, amylcinnamic aldehyde, cyclamen aldehyde, heliotropin, ionone, phenylethyl alcohol, terpineol, undecalactone, and gamma nonyl lactone.

Fragrance compositions as received from a supplier may be provided as an aqueous or organically solvated composition, and may include as a hydrotrope or emulsifier a surface-active agent, typically a surfactant, in minor amount. Such fragrance compositions are quite usually proprietary blends of many different specific fragrance compounds. However, one of ordinary skill in the art, by routine experimentation, may easily determine whether such a proprietary fragrance composition is compatible in the compositions of the present invention.

It is important to select and utilize fragrance formulations that do not adversely affect either the color change polymer stability or reactivity to grease. Fragrance combinations must be tested for functionality and performance with cleaning and polymer compositions.

The hard surface treatment compositions may include a hydrotrope constituent comprising one or more compounds which exhibit a hydrotropic functionality in the inventive compositions. Exemplary hydrotropes include, inter alia, benzene sulfonates, naphthalene sulfonates, C₁-C₁₁ alkyl benzene sulfonates, naphthalene sulfonates, C₅-C₁₁ alkyl sulfonates, C₆-C₁₁ alkyl sulfates, alkyl diphenyloxide disulfonates, and phosphate ester hydrotropes. The hydrotropic compounds of the invention are often provided in a salt form with a suitable counterion, such as one or more alkali, or alkali earth metals, such as sodium or potassium, especially sodium. However, other water soluble cations such as ammonium, mono-, di- and tri-lower alkyl, i.e., C₁-C₄ alkanol ammonium groups can be used in the place of the alkali metal cations. Exemplary alkyl benzene sulfonates include, for example, isopropylbenzene sulfonates, xylene sulfonates, toluene sulfonates, cumene sulfonates, as well as mixtures thereof. Exemplary C₅-C₁₁ alkyl sulfonates include hexyl sulfonates, octyl sulfonates, and hexyl/octyl sulfonates, and mixtures thereof. Particularly useful hydrotrope compounds include benzene sulfonates, o-toluene sulfonates, m-toluene sulfonates, and p-toluene sulfonates; 2,3-xylene sulfonates, 2,4-xylene sulfonates, and 4,6-xylene sulfonates; cumene sulfonates, wherein such exemplary hydrotropes are generally in a salt form thereof, including sodium and potassium salt forms. When present the hydrotrope constituent may be present in any effective amounts, or they may be omitted. Advantageously, when present the hydrotrope constituent comprises 0.001-1.5 wt %. of the composition of which it forms a part.

Hydrotropic constituents should be utilized in combination with the hard surface treatment compositions such that the stability and activity of the hard surface treatment composition activity and stability is maintained.

A further optional constituent are one or more preservatives. Such preservatives are primarily included to reduce the growth of undesired microorganisms within the composition during storage prior to use. Exemplary useful preservatives include compositions which include parabens, including methyl parabens and ethyl parabens, glutaraldehyde, formaldehyde, 2-bromo-2-nitropropoane-1,3-diol, 5-chloro-2-methyl-4-isothiazolin-3-one, 2-methyl-4-isothiazoline-3-one, and mixtures thereof. One exemplary composition is a combination 5-chloro-2-methyl-4-isothiazolin-3-one and 2-methyl-4-isothiazolin-3-one where the amount of either component may be present in the mixture anywhere from 0.001 to 99.99 wt %, based on the total amount of the preservative. Further exemplary useful preservatives include those which are commercially available including a mixture of 5-chloro-2-methyl-4-isothiazolin-3-one and 2-methyl-4-isothiazolin-3-one marketed under the trademark KATHON® CG/ICP as a preservative composition presently commercially available from Rohm and Haas (Philadelphia, Pa.). Further useful and commercially available preservative compositions include KATHON® CG/ICP II, a further preservative composition presently commercially available from Rohm and Haas (Philadelphia, Pa.), PROXEL® which is presently commercially available from Zeneca Biocides (Wilmington, Del.), SUTTOCIDE® A which is presently commercially available from Sutton Laboratories (Chatam, N.J.) as well as TEXTAMER® 38AD which is presently commercially available from Calgon Corp. (Pittsburgh, Pa.).

Preservative constituents should be selected and utilized in combination with the hard surface treatment compositions such that the stability and activity of the hard surface treatment composition activity and stability is maintained.

Optionally one or more abrasives may be included in the hard surface treatment compositions. Exemplary abrasives include: oxides, e.g., calcined aluminum oxides and the like, carbonates, e.g., calcium carbonate and the like, quartzes, siliceous chalk, diatomaceous earth, colloidal silicon dioxide, alkali metasilicates, e.g., sodium metasilicate and the like, perlite, pumice, feldspar, calcium phosphate, organic abrasive materials based on comminuted or particulate polymers especially one or more of polyolefins, polyethylenes, polypropylenes, polyesters, polystyrenes, acetonitrile-butadiene-styrene resins, melamines, polycarbonates, phenolic resins, epoxies and polyurethanes, natural materials such as, for example, rice hulls, corn cobs, and the like, or talc and mixtures thereof. The particle size of the abrasive agent typically may range from about 1 μm to about 1000 μm, preferably between about 10 μm to about 200 μm, and more preferably between about 10 μm and about 100 μm. It is preferred to us those abrasive agents that will not scratch most hard surfaces. Such abrasive agents include calcium carbonate, siliceous chalk, diatomaceous earth, colloidal silicon dioxide, sodium metasilicate, talc, and organic abrasive materials. Calcium carbonate is preferred as being effective and available at a generally low cost. A single type of abrasive, or a mixture of two or more differing abrasive materials may be used.

Abrasive may be utilized in combination with the hard surface treatment composition in various formats. For example, the hard surface treatment composition can be co-mixed with the abrasive or importantly, coated on to the surface of micro-particulate abrasive particles. Each example provides a novel means for deploying the hard surface treatment composition in combination with an abrasive additive.

Optionally the hard surface treatment compositions may include an effective amount of at least one inorganic chloride salt, which are believed to improve the metal cleaning characteristics of the inventive compositions. The inorganic chloride salt is desirably present in an amount effective to provide improved cleaning of metal surfaces which are immersed or contacted with the inventive compositions. The inorganic chloride salt(s) used in the compositions of the present invention can be any water-soluble inorganic chloride salt or mixtures of such salts. For purposes of the present invention, “water-soluble” means having a solubility in water of at least 10 grams per hundred grams of water at 20° C. Examples of suitable salts include various alkali metal and/or alkaline earth metal chlorides including sodium chloride, calcium chloride, magnesium chloride and zinc chloride. Particularly preferred are sodium chloride and calcium chloride which have been surprisingly observed to provide excellent metal cleaning efficacy particularly of aged copper surfaces. The inorganic chloride salt(s) is present in the compositions of the present invention in an amount which will provide an improved cleaning of metal surfaces, particularly copper surfaces, compared to an identical composition which excludes the inorganic chloride salts(s). Preferably the inorganic chloride salt(s) are present in amounts of from about 0.00001 to about 2.5 wt %, desirably in amounts of 0.001 to about 2 wt %, yet more desirably from about 0.01 to about 1.5 wt % and most desirably from about 0.2 to about 1.5 wt %. In certain preferred embodiments the sole inorganic salts present are one or more inorganic chloride salts.

The hard surface treatment compositions may include a thickener constituent which may be added in any effective amount in order to increase the viscosity of the compositions. Exemplary thickeners useful in the thickener constituent include one or more of polysaccharide polymers selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gum, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Exemplary polycarboxylate polymers thickeners have a molecular weight from about 500,000 to about 4,000,000, preferably from about 1,000,000 to about 4,000,000, with, preferably, from about 0.5% to about 4% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

Exemplary clay thickeners comprise, for example, colloid-forming clays, for example, such as smectite and attapulgite types of clay thickeners. The clay materials can be described as expandable layered clays, i.e., aluminosilicates and magnesium silicates.

The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Preferred thickeners are those which provide a useful viscosity increasing benefit at the ultimate pH of the compositions.

As is noted above, the hard surface treatment compositions according to the invention are largely aqueous in nature. Water is added in to order to provide to 100 wt % of the compositions of the invention. The water may be tap water, but is preferably distilled and is most preferably deionized water. If the water is tap water, it is preferably substantially free of any undesirable impurities such as organics or inorganics, especially minerals salts which are present in hard water which may thus undesirably interfere with the operation of the constituents present in the aqueous compositions according to the invention. Preferably at least 80 wt %, more preferably at least 85 wt % of the compositions are water.

Alternately the hard surface treatment compositions of the invention may be supplied as a cleaning agent on a cleaning article, especially a disposable cleaning article such as a wipe, wherein water is only optionally present or is wholly omitted, which thus provides as a further aspect of the invention a surface treatment article comprising a hard surface treatment composition according to the first, second or other aspect of the invention disclosed above which only optionally contains water.

While in certain embodiments the hard surface treatment compositions may comprise a thicker constituent, it is generally preferred the compositions exhibit viscosities similar to that of water. The compositions preferably have a viscosity of not more than about 50 cps at room temperature, more preferably have a viscosity of not more than about 30 cps at room temperature.

Thickening constituents should be selected and utilized in combination with the hard surface treatment compositions such that the stability and activity of the hard surface treatment composition activity and stability is maintained.

The compositions according to the invention are desirably provided as a ready to use product which may be directly applied to a hard surface. Hard surfaces which are to be particularly denoted are lavatory fixtures, lavatory appliances (toilets, bidets, shower stalls, bathtubs and bathing appliances), wall and flooring surfaces especially those which include refractory materials and the like. Further hard surfaces which are particularly denoted are those associated with dishwashers, kitchen environments, hospitals, food service institutions, semi-conductor manufacturing, in the automotive industry, childcare and general manufacturing. Such hard surfaces described above are to be understood as being recited by way of illustration and not be way of limitation.

Utilization of various forms of a polydiacetylenic polymer provides a wide range of different cleaning composition products and product formats to be deployed. Said microcrystalline, liposomal, colloidal, particulate, macromolecular, or soluble polydiacetylene polymer compositions can be utilized in a cleaning product that best utilizes the inherent properties of the particular phase that the polymer has been formed in. By way of example, selected states of the polymer composition can be utilized in solution phases, e.g, as pourable or pumpable liquids which may be either in a “ready to use” format, or in a concentrated format wherein the hard surface treatment composition is intended to be dispersed or dissolved into a larger volume of water; in viscous paste phases, e.g., in the form of viscous or thickened gels or pastes; in dried powder phases, e.g, as free flowing, agglomerated or compressed or tabletted particulate materials; as particle coated phases, and co-mixed phases and separated phase states, e.g., wherein the hard surface treatment compositions may form two or more distinct liquid layers when left in a quiescent state, but which may be temporarily combined by mixing or shaking just prior to use, or alternately wherein two or more separate liquid compositions at are combined at the point of use just prior to or upon use to form the hard surface treatment composition.

It is desirable to match the phase state of a polydiacetylenic polymer with the phase state of intended cleaning composition. For example, solution phase cleaning compositions will benefit from utilizing a polydiacetylenic polymer produced in a liposomal, water soluble, colloidal, or suspended microcrystalline state. Abrasive cleansers can benefit from utilizing a polydiacetylenic polymer in a micro-particulate, micro-crystalline, or particle coated form. Cleaning wipes can benefit from coating a fibre of the wipe with an intercalatingfbinding microcrystalline form of a polydiacetylenic polymer.

The hard surface treatment compositions may be packaged in any suitable container particularly flasks or bottles, including squeeze-type bottles, as well as bottles provided with a spray apparatus which is used to dispense the composition by spraying. For spray-on solutions the polydiacetylenic component can be dissolved or suspended in the cleaning agent. The hard surface treatment compositions are readily pourable and readily pumpable cleaning compositions which features the benefits described above. Accordingly the inventive compositions are desirably provided as a ready to use product in a manually operated spray dispensing container, or may be supplied in aerosolized product wherein it is discharged from a pressurized aerosol container. Propellants which may be used are well known and conventional in the art and include, for example, a hydrocarbon, of from 1 to 10 carbon atoms, such as n-propane, n-butane, isobutane, n-pentane, isopentane, and mixtures thereof; dimethyl ether and blends thereof as well as individual or mixtures of chloro-, chlorofluoro- and/or fluorohydrocarbons- and/or hydrochlorofluorocarbons (HCFCs). Useful commercially available compositions include A-70 (Aerosol compositions with a vapour pressure of 0.49 MPa gauge (70 psig) available from companies such as Diversified and Aeropress) and Dymel® 152a (1,1-difluoroethane from DuPont). Compressed gases such as carbon dioxide, compressed air, nitrogen, and possibly dense or supercritical fluids may also be used. In such an application, the composition is dispensed by activating the release nozzle of said aerosol type container onto the area in need of treatment, and in accordance with a manner as above-described the area is treated (e.g., cleaned and/or sanitized and/or disinfected). If a propellant is used, it will generally be in an amount of from about 1% to about 50% of the aerosol formulation with preferred amounts being from about 2% to about 25%, more preferably from about 5% to about 15%. Generally speaking, the amount of a particular propellant employed should provide an internal pressure of from about 20 to about 1.05 MPa gauge (150 psig) at 21.1° C. (70° F.).

In a further embodiment the spray solutions can be such that the hard surface treatment composition can be separately housed in one spray vessel as an indicating solution and the cleaning solution separately housed in a second vessel such that the two compositions are mixed at the time of spraying and not prior to spraying and cleaning.

As outlined above the compositions according to the invention can also be suited for use in a consumer “spray and wipe” application as a cleaning composition. In such an application, the consumer generally applies an effective amount of the composition using the pump and within a few moments thereafter, wipes off the treated area with a rag, towel, or sponge, usually a disposable paper towel or sponge. In certain applications, however, especially where undesirable stain deposits are heavy, the cleaning composition according to the invention may be left on the stained area until it has effectively loosened the stain deposits after which it may then be wiped off, rinsed off, or otherwise removed. For particularly heavy deposits of such undesired stains, multiple applications may also be used. Optionally, after the composition has remained on the surface for a period of time, it could be rinsed or wiped from the surface.

The hard surface treatment compositions can also be powdered non-abrasive cleaners where the polydiacetylenic component is co-blended with a powdered detergent and suspended in liquid form when the detergent is hydrated for use or powdered abrasive cleaners where the polydiacetylenic component is co-blended with the abrasive component or coated on the abrasive component.

Further utility of an added hard surface treatment composition can be gained by utilizing the thermochromic properties of a cleaning solution containing the polydiacetylenic polymer constituent. Elevated temperatures can be utilized during cleaning as a means of disinfecting the surface to be cleaned. The thermochromic properties of the polydiacetylenic polymer can be utilized to initially indicate that a desired elevated temperature has been achieved during use. The grease activated color change properties can be further utilized by visualizing a grease induced color change once the thermal color change of the polydiacetylenic polymer has been reversed.

Whereas the compositions of the present invention are intended to be used in the types of liquid forms described, nothing in this specification shall be understood as to limit the use of the composition according to the invention with a further amount of water to form a cleaning solution there from. In such a proposed diluted cleaning solution, the greater the proportion of water added to form said cleaning dilution, the greater may be the reduction of the rate and/or efficacy of the thus formed cleaning solution. Accordingly, longer residence times upon the stain to effect their loosening and/or the usage of greater amounts may be necessitated. Conversely, nothing in the specification shall be also understood to limit the forming of a “super-concentrated” cleaning composition based upon the composition described above. Such a super-concentrated ingredient composition is essentially the same as the cleaning compositions described above except in that they include a lesser amount of water.

As outlined above, the hard surface treatment composition of the present invention, whether as described herein or in a concentrate or super concentrate form, can also be applied to a hard surface by the use of a carrier substrate. One example of a useful carrier substrate is a wipe. The wipe can be of a woven or non-woven nature. Such fabrics are known commercially in this field and are often referred to as wipes. Such substrates can be resin bonded, hydroentangled, thermally bonded, meltblown, needle punched, or any combination of the former. The wipe can be of a woven or non-woven nature.

The nonwoven fabrics may be a combination of wood pulp fibers and textile length synthetic fibers formed by well known dry-form or wet-lay processes. Synthetic fibers such as rayon, nylon, orlon and polyester as well as blends thereof can be employed. The wood pulp fibers should comprise about 30 to about 60 percent by weight of the nonwoven fabric, preferably about 55 to about 60 percent by weight, the remainder being synthetic fibers. The wood pulp fibers provide for absorbency, abrasion and soil retention whereas the synthetic fibers provide for substrate strength and resiliency.

The substrate of the wipe may also be a film forming material such as a water soluble polymer. Such self-supporting film substrates may be sandwiched between layers of fabric substrates and heat sealed to form a useful substrate. The free standing films can be extruded utilizing standard equipment to devolatilize the blend. Casting technology can be used to form and dry films, or a liquid blend can be saturated into a carrier and then dried in a variety of known methods.

The hard surface treatment compositions of the present invention are absorbed onto the wipe to form a saturated wipe. The wipe can then be sealed individually in a pouch which can then be opened when needed or a multitude of wipes can be placed in a container for use on an as-needed basis. The container, when closed, is sufficiently sealed to prevent evaporation of any components from the compositions.

Sponges including both closed cell and open celled sponges, including sponges made from celluloses as well as other polymeric materials, as well as in the form of abrasive or non-abrasive cleaning pads containing the hard surface treatment compositions described herein may also be used and are also generally considered to be wipes falling within the scope of the present invention.

In use with the hard surface treatment compositions of the present invention as described above when provided to a wipe will cause the wipe to undergo a color change when an oleophilic soil, for example, when an oil or greasy stain or deposit, is detected and contacted by the wipe.

The hard surface treatment compositions of the invention as described herein may also be used to indicate the presence of soap scum on a surface, including a hard surface, by contact with the polydiacetylenic polymer present in the hard surface treatment composition, or wipe containing the hard surface treatment, with a soap scum deposit.

By “hard surface”, we include ceramics, glass, stone, plastics, marble, metal and/or wood surfaces, such as, in the household environment for example, bathroom and kitchen hard surfaces such as sinks, bowls, toilets, drains, panels, tiles, worktops, dishes, floors, and the like.

Whereas the compositions of the invention have been primarily discussed as being useful in conjunction with hard surfaces, there is nothing in this specification which is to be understood that such is a specific limitation but rather, it is to be expressly understood that the so-called hard surface treatment compositions taught herein, as well as wipes containing the so-called hard surface treatment compositions may be used on surfaces other than hard surfaces, namely on so-called soft surfaces, e.g., textiles, clothing, carpets, curtains, upholstery, textile and fabric covered articles, and the like wherein the presence of oleophilic stains or deposits, e.g. greasy or oily stains are present or suspected to be present.

Indeed, it is to be expressly understood that the so-called hard surface treatment compositions discussed herein may find use on any of a number of inanimate surfaces, including non-dermal surfaces, including but not limited to both hard and soft surfaces as discussed above.

The hard surface treatment composition can also be in the form of a cleaning stick wherein the polydiacetylenic polymer is dispersed in a solid detergent stick and applied to a surface as the stick is pressed and applied to the surface.

Certain embodiments of the invention, including certain particularly preferred embodiments of the invention are disclosed in the following Examples.

### EXAMPLE 1

A composition according to the invention was produced using the following constituents.

TABLE 1

| Constituent | tradename | % w/w |
|---|---|---|
| deionised water | — | q.s. |
| N-(hydroxyethyl)-tetradeca-4,6-diynylamide | — | 0.250 |
| CH₃—(CH₂)₆—(C≡C)₂—(CH₂)₂—CO—NH—CH₂—CH₂—OH | | |
| monoethanolamine 99% | MEA LCI | 0.750 |
| non-ionic amine oxide surfactant | Ammonyx LO | 2.000 |
| cationic surfactant, quaternary ammonium compound; | BTC 65 | 0.172 |
| Benzalkonium-CL 50% | | |
| cationic surfactant, quaternary ammonium compound; | BTC 8358 | 0.027 |
| Benzalkonium-CL 80% | | |
| organic solvent, dipropyleneglycol n-butylether | Dowanol DPnB | 1.000 |
| organic solvent, n-decanol | — | 0.020 |
| fragrance | — | 0.200 |

The formulation in Table 1 is indicated in weight percent, and the composition comprised 100 wt %; water was supplied in “quantum sufficient” to provide the balance to 100 wt. %.

The formulation was produced by mixing the constituents outlined in Table 1 by adding the individual constituents into a beaker containing deionized water at room temperature which was stirred with a conventional magnetic stirring rod. Stirring continued until the formulation was homogeneous in appearance. It is to be noted that the constituents may be added in any order, The order of addition is not critical, but good results are obtained where the surfactants (which may be also the pre-mixture of the fragrance and surfactants) are added to the water prior to the remaining constituents.

A standardized greasy soil was prepared by blending the following weight proportions of: ⅓ Crisco®. ⅓ lard and ⅓ vegetable oil, which was thereafter smeared onto a nonporous hard surface. Thereafter a quantity of the above formulation, which was initially blue was applied to the smeared hard surface. After two minutes the above formulation which had come into contact with the grease turned pink. The rate of color change was observed to vary dependant upon the thickness of the grease layer and/or the dispersion of the polydiacetylene polymer within the grease.

### EXAMPLE 2

A further composition according to the invention was produced using the following constituents.

TABLE 2

| Constituent | tradename | % w/w |
|---|---|---|
| deonized water | — | q.s. |
| N-ethyl-eicosa-5,7-diynylamide | — | 0.25 |
| CH₃—(CH₂)₁₁—(C≡C)₂—(CH₂)₃—CO—NH—CH₂—CH₃ | | |
| ethanol 95% | — | 3.00 |
| cationic surfactant, quaternary ammonium compound; | BTC 8358 | 0.80 |
| Benzalkonium chloride 80% | | |

The formulation in Table 2 is indicated in weight percent, and the total composition comprises 100 wt %; water was supplied in “quantum sufficient” to provide the balance to 100 wt. %.

The formulation was produced by mixing the constituents outlined in Table 1 by adding the individual constituents into a beaker containing deionized water at room temperature which was stirred with a conventional magnetic stirring rod. Stirring continued until the formulation was homogeneous in appearance. It is to be noted that the constituents may be added in any order, The order of addition is not critical, but good results are obtained where the surfactants (which may be also the pre-mixture of the fragrance and surfactants) are added to the water prior to the remaining constituents.

A standardized greasy soil was prepared by blending the following weight proportions of: ⅓ Crisco®. ⅓ lard and ⅓ vegetable oil, which was thereafter smeared onto a nonporous hard surface. Thereafter a quantity of the above formulation, which was initially blue was applied to the smeared hard surface. After two minutes the above formulation which had come into contact with the grease turned pink. The rate of color change was observed to vary dependant upon the thickness of the grease layer and/or the dispersion of the polydiacetylene polymer within the grease.

The following provide further illustrative example compositions falling with the scope of the present invention:

The composition of Table 3 illustrates an exemplary multi-purpose, ready-to-use liquid hard surface cleaning composition comprising a polydiacetylene polymer comprised of one or more diacetylene monomers of the type (a)-(l) disclosed above which may be made.

TABLE 3

| | % w/w |
|---|---|
| nonionic surfactant, C₁₀-C₁₆ dimethylamine oxide | 0.5-3.5 |
| organic solvent, dipropylene glycol n-butyl ether | 0.25-2.2 |
| organic solvent, C₄-C₁₂ alcohol | 0.01-2 |
| cationic surfactant, benzalkonium chloride | 0.05-1.1 |
| monoalkanolamine | 0-1.5 |
| fragrance, colorant | 0-1.2 |
| polydiacetylene polymer | 0.001-10 |
| deionized water | q.s. |

The composition of Table 4 illustrates an exemplary multi-purpose, ready-to-use liquid hard surface cleaning and disinfecting/sanitizing composition comprising a polydiacetylene polymer comprised of one or more diacetylene monomers of the type (a)-(l) disclosed above which may be made.

TABLE 4

| | % w/w |
|---|---|
| anionic surfactants | 0.5-5 |
| nonionic surfactant, EO/PO block copolymer | 0.1-1.2 |
| organic solvent, dipropylene glycol n-butyl ether | 0.25-3.6 |
| organic solvent, C₄-C₁₂ alcohol | 0-2 |
| monoalkanolamine | 0-1.5 |
| citric acid | 0.5-5 |
| hydroxyacetic acid | 0.5-5 |
| fragrance, colorant | 0-1.2 |
| polydiacetylene polymer | 0.001-10 |
| deionized water | q.s. |

The composition of Table 5 illustrates an exemplary multi-purpose, ready-to-use hard surface treatment composition comprising a polydiacetylene polymer comprised of one or more diacetylene monomers of the type (a)-(l) disclosed above used to impregnate a wipe article, wherein the composition was applied at a loading level of approx. 45-65 grams composition per square meter of dry wipe substrate which may be made.

TABLE 5

| | % w/w |
|---|---|
| organic solvent, C₄-C₁₂ alcohol | 0.5-6.5 |
| cationic surfactant, benzalkonium chloride | 0.25-2.25 |
| fragrance, colorant | 0-1.2 |
| polydiacetylene polymer | 0.001-10 |
| deionized water | q.s. |

Although the composition of Table 5 illustrates a significant amount of water, water may be omitted from the composition.

1. A hard-surface cleaning composition comprising:
a. a surfactant;
b. a microcrystalline, liposomal, colloidal, particulate, macromolecular, supported or soluble polydiacetylene polymer or,
a polydiacetylene polymer supported on or associated with a carrier particulate;
c. optionally, an organic solvent; and
d. water;
wherein, when the composition contacts fatty materials, e.g., greasy or oily, said polydiacetylene polymer changes color from a first color to a second color or alternately, changes firom a first color to a colorless appearance, or said polydiacetylene polymer changes color from a first color to a second color or alternately, changes from a first color to a colorless appearance.

2. (canceled)

3. The hard-surface cleaning composition according to claim 1 wherein the polydiacetylene polymer is a polydiacetylene polymer which comprises at least one diacetylene monomer of formula:
R(CH₂)ₙ(C≡C)₂(CH₂)ₘY
wherein:
Y is —COX, unsubstituted or substituted amino, amide, hydroxy, unsubstituted or substituted alkoxy having from 1 to 20 carbon atoms, —SH, unsubstituted or substituted alkylthio having from 1 to 6 carbon atoms, cyano or halo;
m is at least 1;
n is at least 1;
R is H or Y; and
X is H, OH, unsubstituted or substituted amino, unsubstituted or substituted alkoxy or polyalkyleneoxy, wherein the alkylene group has 1 to 3 carbon atoms and may have from 1 to 50 units.

4. The hard-surface cleaning composition according to claim 3 wherein Y is of formula —COX where X is —NH—(CH₂)ₚ—OH wherein p is from 1 to 20.

5. The hard-surface cleaning composition according to claim 3 wherein m is from 1 to 24.

6. The hard-surface cleaning composition according to claim 3 wherein n is from 6 to 36.

7. The hard-surface cleaning composition according to claim 3 wherein R is H.

8. The hard-surface cleaning composition according to claim 1 wherein the diacetylene monomer is at least one of:

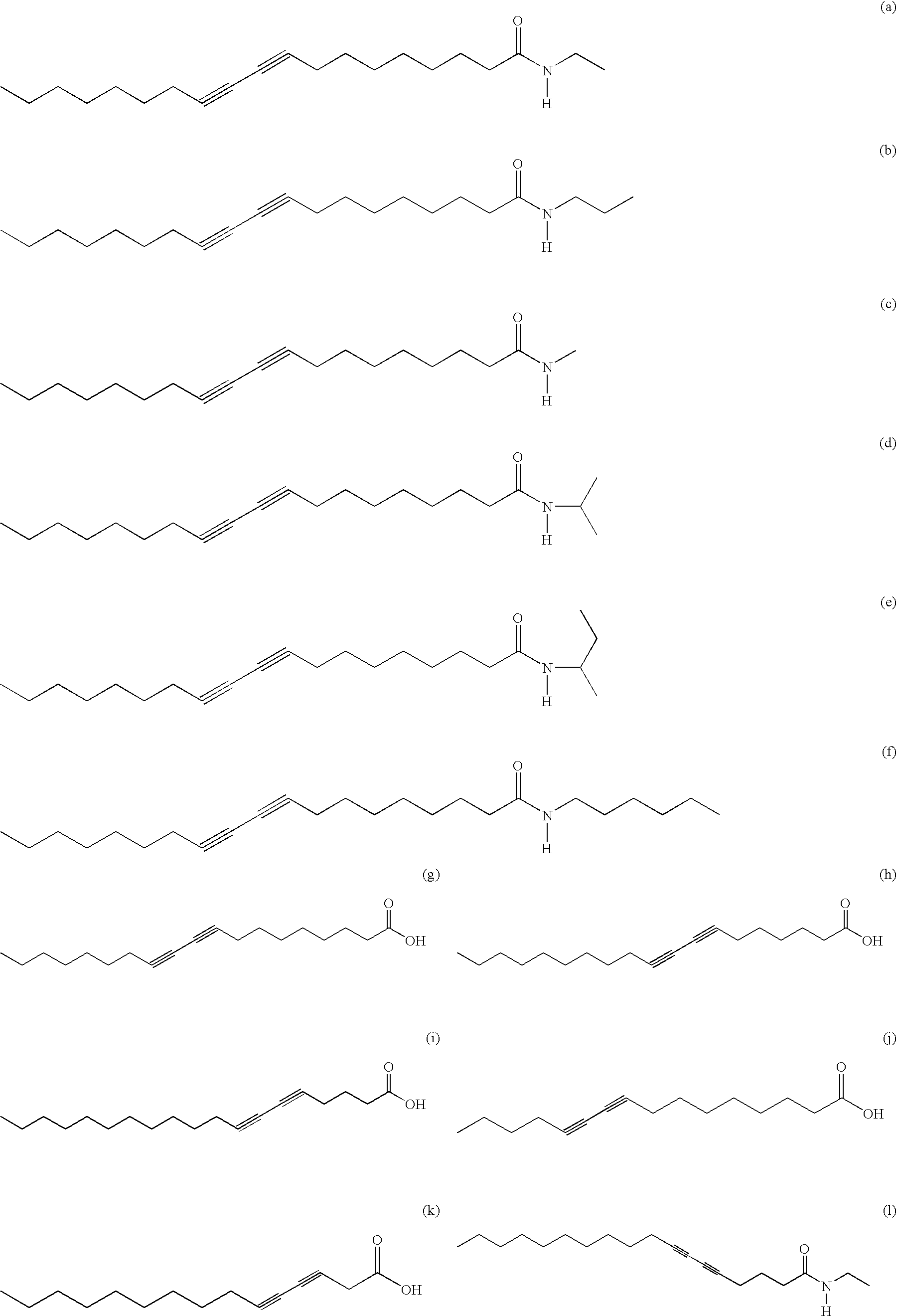

9. The hard-surface cleaning composition according to claim 1 wherein the surfactant is a non-ionic, anionic, cationic, or zwitterionic surfactant.

10. The hard-surface cleaning composition according to claim 1 which comprises from 0.005 to 5.0 wt % of the polydiacetylene polymer based on the total weight of the composition.

11. The hard-surface cleaning composition according to claim 10 which comprises from 0.1 to 0.5 wt % of the polymer based on the total weight of the composition.

12. (canceled)

13. (canceled)

14. (canceled)

15. A method of indicating the presence of a grease or oil on a hard-surface wherein the surface is contacted with the hard-surface cleaning composition according to claim 1.

16. (canceled)

17. A method of indicating the presence of a soap scum or oleophilic residue on a hard-surface wherein the surface is contacted with the hard-surface cleaning composition according to claim 1.

18. (canceled)
